(19) United States
(12) Patent Application Publication
(10) Pub. No.: US 2009/0228693 A1
(43) Pub. Date: Sep. 10, 2009

(54) System and method for large microcoded programs

(76) Inventors: Steven E. Koenck, Cedar Rapids, IA (US); John K. Gee, Mount Vernon, IA (US)

Correspondence Address: FOLEY & LARDNER LLP, 777 EAST WISCONSIN AVENUE, MILWAUKEE, WI, 53202-5306, US

(21) Appl. No.: 11/805,314

(22) Filed: May 22, 2007

(51) Int. Cl. G06F 9/00

(52) U.S. Cl. 712/248

(57) ABSTRACT

An improved architectural approach for implementation of a microarchitecture for a low power, small footprint microcoded processor for use in packet switched networks in software defined radio MANeTs. A plurality of on-board CPU caches and a system of virtual memory allows the microprocessor to employ a much larger program size, up to 64k words or more, given the size and power footprint of the microprocessor.

### CROSS-REFERENCE TO RELATED APPLICATIONS

This application is filed concurrently with commonly assigned, non-provisional U.S. patent applications U.S. patent application Ser. No. (to be assigned), entitled “IMPROVED MOBILE NODAL BASED COMMUNICATION SYSTEM, METHOD AND APPARATUS” listing as inventors Steven E. Koenck, Allen P. Mass, James A. Marek, John K. Gee and Bruce S. Kloster having docket number Rockwell Collins 06-CR-00507; and, U.S. patent application Ser. No. (to be assigned), “ENERGY EFFICIENT PROCESSING DEVICE ” listing as inventors Steven E. Koenck, John K. Gee, Jeffrey D. Russell and Allen P. Mass having docket number Rockwell Collins 06-CR-00508; all incorporated by reference herein.

### BACKGROUND OF THE INVENTION

1. Field of Invention

The present invention relates generally to the field of microprocessors, and in particular to an improved architectural approach for implementation of a microarchitecture for a low power, small footprint microcoded processor for use in packet switched networks in software defined radio MANeTs allowing a microprocessor to employ a much larger program size.

2. Description of Related Art

In computer engineering, microarchitecture is the design and layout of a microprocessor, microcontroller, or digital signal processor. Microarchitecture considerations include overall block design, such as the number of execution units, the type of execution units (e.g. floating point, integer, branch prediction), the nature of the pipetining, cache memory design, and peripheral support.

A microcode is the microprogram that implements a CPU instruction set. A computer operation is an operation specified by an instruction stored in binary, in a computer's memory. A control unit in the computer uses the instruction (e.g. operation code, or opcode), decodes the opcode and other bits in the instruction to perform required microoperations. Microoperations are implemented by hardware, often involving combinational circuits. In a CPU, a control unit is said to be hardwired when the control logic expressions are directly implemented with logic gates or in a PLA (programmable logic array). By contrast to this hardware approach for the control logic expressions, a more flexible software approach may be employed where in a microprogrammed control unit, the control signals to be generated at a given time step are stored together in a control word, called a microinstruction. The collection of these microinstructions is the microprogram, and the microprograms are stored in a memory element termed the control store.

Microprogramming is a systematic technique for implementing the control unit of a computer. Microprogramming is a form of stored-program logic that substitutes for sequential-logic control circuitry. A processing unit (CPU) in a computer system is generally composed into a data path unit and a control unit. The data path unit or data path includes registers, function units such as ALUs (arithmetic logic units), shifters, interface units for main memory and I/O, and internal busses. The control unit controls the steps taken by the data path unit during the execution of a machine instruction or macroinstruction (e.g., load, add, store, conditional branch). Each step in the execution of a macroinstruction is a transfer of information within the data path, possibly including the transformation of data, address, or instruction bits by the function units. The transfer is often a register transfer and is accomplished by sending a copy of (i.e. gating out) register contents onto internal processor busses, selecting the operation of ALUs, shifters, and the like, and receiving (i.e., gating in) new values for registers. Control signals consist of enabling signals to gates that control sending or receiving of data at the registers, termed control points, and operation selection signals. The control signals identify the microoperations required for each register transfer and are supplied by the control unit. A complete macroinstruction is executed by generating an appropriately timed sequence of groups of control signals; with the execution termed the microoperation.

Virtual memory in computer engineering allows simulating more memory than actually exists, allowing a processor to run larger programs. It breaks up a program into small segments, called “pages,” and brings many pages, typically from a secondary storage, such as a hard drive disk, into another memory, typically a primary storage such as RAM, and fits them into a reserved area. The computer operating system typically has a paging memory allocation algorithm to divide computer memory into small partitions, and allocates memory using a page as the smallest building block. When additional pages are required, a processor makes room for them by swapping a page from RAM to disk. Virtual memory keeps track of pages that have been modified so that they can be retrieved when needed again. Virtual memory can be implemented in software only, but efficient operation requires virtual memory hardware. Virtual memory claims are sometimes made for specific applications that bring additional parts of the program in as needed; however, true virtual memory is a hardware and operating system implementation that works with all applications.

A memory cache, or “CPU cache,” is a memory bank that bridges main memory and the CPU (processor). A memory cache is faster than main memory, being closer to the processor, as well as having faster access times since the cache is usually SRAM as opposed to slower main memory DRAM. A memory cache allows instructions to be executed and data to be read and written at higher speed. Instructions and data are transferred from main memory to the cache in blocks, using some kind of look-ahead algorithm. The more sequential the instructions in the routine being executed or the more sequential the data being read or written, the greater chance the next required item will already be in the cache, resulting in better performance. Cache may be classified as a level 1 (L1) cache, which is a memory bank built into the CPU chip, or as a level 2 cache (L2), which is found in a secondary staging area that feeds the L1 cache. L2 may be built into the CPU chip, reside on a separate chip in a multichip package module (see MCP) or be a separate bank of chips on the motherboard. Caches are typically static RAM (SRAM), while main memory is generally some variety of dynamic RAM (DRAM).

Network technology has become a basic building block for the design and composition of nearly every type of digital processing system in use today. The Internet has become the world's largest communication system, and has established standards for network communications between systems of sizes ranging from household appliances to mainframe computers. A critical component for the implementation of network system infrastructure is the network router, which has the responsibility of directing network traffic (typically in the form of packets of data) to the correct place. The Internet Protocol is based on connectionless routing, which means that no previously established path for an incoming packet is known, but instead the router must examine the contents of each packet and determine the appropriate forwarding path as quickly as possible. Router technology for the Internet is in its fourth major generation, with major investments being made to develop fifth generation optical switch core technology. The principal that smaller is generally better may be applied to networking. While there is certainly great value in huge networks like the Internet, there is also potential for great value in small footprint networks as well.

A fundamental building block by which modern network routers are constructed is the network processor. Network processors have taken multiple forms, beginning with embedded microprocessors, evolving to multiple parallel microengines and increasingly migrating to hardware solutions. The industry demands for higher performance have driven the solutions toward greater complexity, size and power consumption.

Microcoded processors have been used for many years as an architectural approach to a variety of computing problems. The best known microcoded processors are the core execution units in the Intel×86 families. Other examples include the 1970's vintage bit slice chip sets, the Rockwell Collins AAMP microprocessor family, and more recently the Intel IXP network processor family. In each of these microcoded processors, a relatively small microcode memory (thousands of lines of microcode) is provided. The microcode may be fixed (ROM) or variable (RAM), but is typically configured in some initialization phase, and remains in place for the duration of the computing mission.

The approach of the Intel IXP network processor family is perfectly reasonable when the microcode exists for the purpose of implementing the functionality of a system component. However, it has been recognized by the present invention that it may be feasible to implement relatively large application programs using software development techniques to generate microcode that can execute on very small, low power microarchitecture. If microcode is used to implement higher level functionality, the size of the microcoded program may be quite large. Existing microarchitectures have not been designed to accommodate microprograms of such complexity and scope. It is certainly possible to employ virtual memory and caching techniques like the kind employed by most high performance microprocessors. However, a significant disadvantage of these approaches is their complexity and power consumption. What is needed is a method for hosting and executing large microprograms without incurring the overhead of a large, high performance microprocessor. The present invention addresses these concerns.

### SUMMARY OF THE INVENTION

Accordingly, an aspect of the present invention is the implementation of very small, tow power embedded computing systems. The herein described Network Processor core operates in overall scope with microcoded processors that have been developed in the past but with further simplification, which, inter atia, reduces the size of the processor and power footprint to less than 10 milliwatts. An advantageous aspect of the present invention is the means for the microcode program size to be much larger—for example 64k words or more—by means of a type of virtual memory. A microprogram of this size could implement system designs of substantial complexity, while still utilizing a small, tow power microarchitecture core.

In an embodiment of the invention, large microprograms may be capable of being executed on a small core through a limited cache to load and execute small portions of the large microprogram. The microprogram storage organization may include three blocks:
a system microprogram block for initialization, control and system management functions;
a first microprogram execution cache that is loaded with microcode from external memory;
a second microprogram execution cache that is also loaded with microcode from external memory.

In an additional aspect of the present invention, the processing device of the present invention may be implemented as a network router solution that is smaller than conventional network processors, making it possible to construct “real” networks (including IP services, for example) in a miniature size and reduced power footprint. The core architecture of the processing device may comprise a programmable microcoded sequencer (a microsequencer) to implement state management and control, a data manipulation subsystem controlled by fully decoded microinstructions, specialized memory with searching facilities for logical to physical address resolution, and interface facilities for the core to communicate with network interface facilities such as Media Access Controllers (MACs) and a host computer. The core architecture of the present invention may employ fully decoded microcoded controls rather than use of extensive opcodes like a typical microprocessor. Fully decoded microcode enables a rich set of controls and data manipulation capabilities at the cost of a somewhat more complex mental model for the microcode developer to manage. A key benefit of fully decoded microcode is that it enables an extremely simple microarchitecture. Initial estimates of a network processor core with capability to manage a subnetwork with up to 16,000 nodes could be implemented in as few as 20,000 gates and 132k bytes of RAM. In a 90 nm CMOS process, this would require approximately 1.45 mm2 of chip area and operate on nominally 4 milliwatts at 100 MHz.

The processing device of the present invention may be implemented in an Application Specific Integrated Circuit (ASIC) device comprised of a set of programmable building blocks. The key building blocks are termed cores which refer to small microcoded computing modules that can be loaded with programs that implement the desired computing behavior. The processing device architecture may include two basic core types: a MAC core, not shown herein (the subject matter of commonly assigned pending patent applications docket number Rockwell Collins 06-CR-00507 and 06-CR-00508, referenced herein and incorporated by reference herein) and a Network Processor core. Each of these cores has facilities designed for a specific set of functions.

The Network Processor core has a microsequencer coupled to an 8 bit data manipulation subsystem optimized for performing network routing functions (the lower portions of ISO Layer 3). A fast memory content search is implemented with a subsystem of a RAM, hardware address counter, and hardware data comparator, so network addresses can be searched linearly at core speeds. This approach is slower than typical Internet routers, but is also much smaller and consumes lower power.

A critical capability of the processing device is to forward network packets to the proper next physical destination as quickly as possible, so to minimize accumulation of data latency. This forwarding operation is performed primarily by the Network Processor core, which analyzes the IP Destination Address in each packet and looks up in its routing table the physical (MAC) address that the packet should be sent to next. Maintenance of the routing table is an upper Layer 3 function that will be performed by the host processor. It is anticipated that the basic packet forwarding operation will be performed in less than 2 msec. average, which makes it possible for packets to forward up to 100 hops end-to-end. This could enable VoIP services on mesh networks for up to 10,000 users.

A beneficial feature of the core implemented packet forwarding system is the fact that the host processor is not involved in the majority of the operation of the network infrastructure, and may therefore remain in an idle or sleeping condition most of the time. This makes it possible to save a substantial amount of battery power while providing very high packet forwarding performance.

The architecture of the present invention, though preferably an ASIC device comprised of a set of programmable building blocks, can be implemented in any combination of hardware and/or software such as a Programmable Logic Device (PLD).

The sum total of all of the above advantages, as well as the numerous other advantages disclosed and inherent from the invention described herein, creates an improvement over prior techniques.

The above described and many other features and attendant advantages of the present invention will become apparent from a consideration of the following detailed description when considered in conjunction with the accompanying drawings.

### BRIEF DESCRIPTION OF THE DRAWINGS

Detailed description of preferred embodiments of the invention will be made with reference to the accompanying drawings. Disclosed herein is a detailed description of the best presently known mode of carrying out the invention. This description is not to be taken in a limiting sense, but is made merely for the purpose of illustrating the general principles of the invention. The section titles and overall organization of the present detailed description are for the purpose of convenience only and are not intended to limit the present invention.

FIG. 1 is a schematic of a prior art network processor, the Intel IXP1200.

FIG. 2 is a general small footprint network processor according to the present invention.

FIG. 3 a block diagram of the core cache architecture of the present invention.

FIG. 4 is a flow chart illustrating a method of running a microprogram on a core of a microprocessor, in accordance with an exemplary embodiment of the present invention.

It should be understood that one skilled in the art may, using the teachings of the present invention, vary embodiments shown in the drawings without departing from the spirit of the invention herein. In the figures, elements with like numbered reference numbers in different figures indicate the presence of previously defined identical elements.

### DETAILED DESCRIPTION OF THE INVENTION

The present invention involves routing, in a mesh network topology, in a SDR network. A plurality of nodes each act as a transmitter and receiver, in a packet switching network forming a MANeT, with the nodes following a communications protocol such as the OSI (ISO) or IEEE model, preferably the IEEE 802.11 or equivalent. The nodes each have a network processor, as described further herein, preferably an ASIC device formed form a set of programmable building blocks comprising cores. The cores comprise at least one Network Processor core, as further taught herein. The cores are fast, scalable and consume low power.

The network typically employs hop-by-hop (HBH) processing to provide end-to-end reliability with fewer end-to-end transmissions, and can engage in intermediate node routing. A hop is a transmission path between two nodes. Network coding (described herein) further reduces end-to-end transmissions for multicast and multi-hop traffic. Each of the nodes has a plurality of input and output ports that may perform multiplexing by time division and/or space division, but preferably TDMA. The switches may operate in a “pass-through” mode, where routing information contained in the packet header is analyzed, and upon determination of the routing path through the switch element, the packet is routed to the appropriate switch port with minimum delay. Alternatively, the switches may operate in a store-and-forward mode with suitable buffers to store message cells or packets of data. The packets having a header, trailer and payload, as explained further herein. The switched fabric network preferably uses a “wormhole” router approach, whereby the router examines the destination field in the packet header. Wormhole routing is a system of simple routing in computer networking based on known fixed links, typically with a short address. Upon recognition of the destination, validation of a header checksum, and verification that the route is allowed for network security, the packet is immediately switched to an output port with minimum time delay. Wormhole routing is similar to Asynchronous Transfer Mode (ATM) or Multi-Protocol Label Switching (MPLS) forwarding, with the exception that the message does not have to be queued.

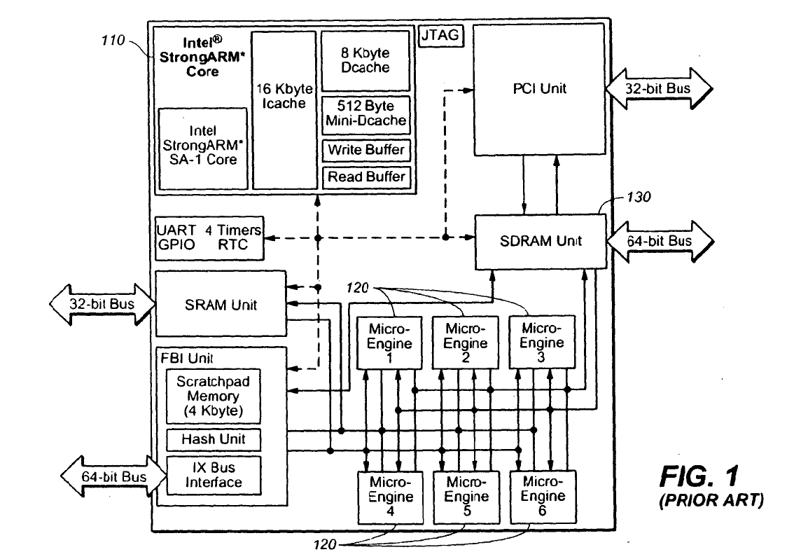

FIG. 1 is a schematic of a prior art network processor, the Intel IXP1200. The Intel IXP network processor family is a microcoded processor family, where each processor a relatively small microcode memory (thousands of lines of microcode). The microcode may be fixed (ROM) or variable (RAM), but is typically configured in some initialization phase, and remains in place for the duration of the computing mission. This prior art network processor involves the use of numerous opcodes in its microarchitecture, giving it flexibility. An Intel StrongARM Core is a control unit that performs logical operations and several microengines that may be cores from the StrongARM family to] provide switching, with on-board SRAM. In a programmable microprocessor, the complete macroinstruction is executed by generating an appropriately timed sequence of groups of control signals, with the execution termed the microoperation. While the microoperations in the Intel IXP are ultimately implemented by hardware, they are generated through microinstructions in the form of operational codes that are require more time to execute than a fully decoded microcoded control signal for use as a microoperation, one that does not require numerous opcodes, as the present invention teaches. Thus while the use of microcoded network processors for implementation of functions such as network routing is well known in the art, such as in the Intel IXP1200 family, the novelty of core solution of the present invention is in its architecture, and particularly its use of fully decoded microcoded controls rather than in the use of numerous opcodes like a typical network microprocessor, as found in the Intel IXP 1200. The fully decoded microcode of the present invention enables a rich set of controls and data manipulation capabilities at the cost of a somewhat more complex mental model for the microcode developer to manage. A key benefit of fully decoded microcode is that it enables an extremely simple microarchitecture. Initial estimates of a network processor core with capability to manage a subnetwork with up to 16,000 nodes could be implemented in as few as 20,000 gates and 132k bytes of RAM. In a 90 nm CMOS process, this would require approximately 1.45 mm² of chip area and operate on nominally 4 milliwatts at 100 MHz.

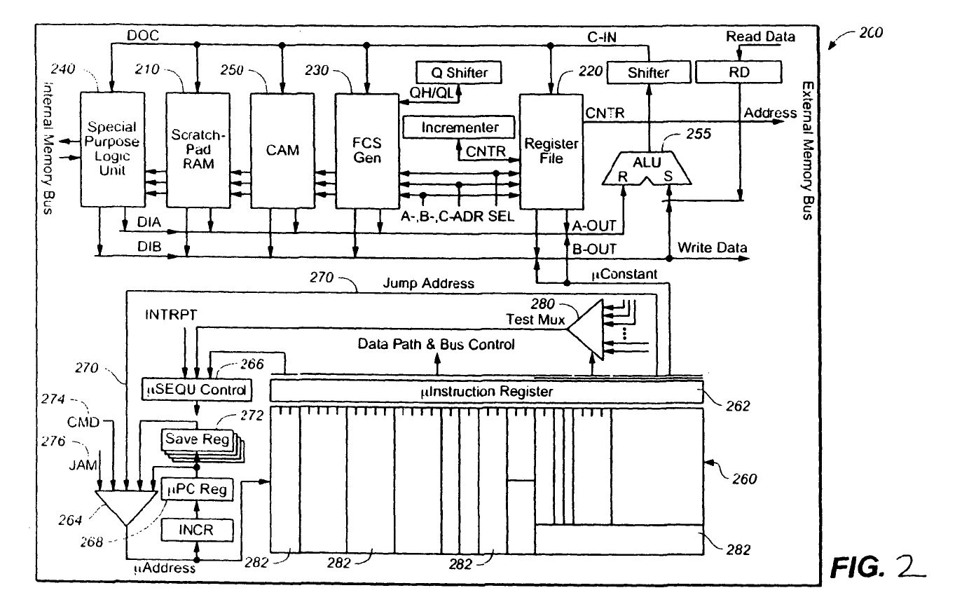

Turning attention to FIG. 2, there is shown a general small footprint, low power network processor 200 according to the present invention. The architecture of the general small footprint, low power network processor 200 may be termed a core architecture, which can be implemented in a variety of different ways, typically as an embedded microprocessor in a network, as a network processor (explained further herein).

The core architecture of the present invention saves power by performing various computing functions in a novel way, thereby using the minimum number of gate switch operations (‘toggles’), which are the electrical operations that consume energy in CMOS integrated circuits. Broadly, the core architecture (hereinafter “core”) saves energy when compared to prior art architecture in four ways: first, using a non-opcode oriented, fully decoded microcode (fully decoded microinstructions) as the native execution language in a microcoded control unit, generated by either manual or automated means, but does not require an instruction decoder for execution; second, using multiptexer-based register select/write logic; third, using a small number of gates so that the toggles are kept low; and fourth, using a predetermined, fixed microarchitecture as the execution environment, which enables the use of a hardwired ASIC implementation rather than an FPGA implementation.

Thus, to save energy, in a preferred embodiment of the present invention, first fully decoded microcode (fully decoded microinstructions) is used for the native execution language, thereby reducing the numerous instructions needed in the decoding stage of a classic RISC based microprocessor. Fully decoded microinstructions may include fully decoded microcoded control signals and/or data. It is contemplated that fully decoded microinstructions do not require compiling or decompiling.

By way of example and not of limitation, if a fully decoded microinstruction was for taking the cosine of a floating point number X, suitable hardware in the microcode would be able to compute the cosine of the number, to a predetermined degree of accuracy (e.g. using a power series comprising Taylor's formula), when presented with a suitable machine language version instruction of “COSINE X”, rather than have to parse and decode the instruction “COSINE” into a series of shorter instructions, such as a series of instructions for multiplications, divisions, additions, subtractions, and moving data into and out of registers and memory, and the like, using a decoding logic state, as in the prior art, e.g. with RISC microprocessors.

The present invention contemplates, and those skilled in the art would appreciate, that the core architecture of the present invention is preferably capable of processing any machine readable instruction. The core instructions may preferably be 4 byte words and may be fixed or variable in length.

Examples of fully decoded instructions include categories such as: moving—to set a register (in the CPU itself) to a fixed constant value; to move data from a memory location to a register; to read and write data from hardware devices; computing—to add, subtract, multiply, or divide the values of two registers, placing the result in a register; to perform bitwise operations, taking the conjunction/disjunction (and/or) of corresponding bits in a pair of registers, or the negation of each bit in a register; to compare two values in registers; and, affecting program flow, to jump to another location in the program and execute instructions there; to jump to another location if a certain condition holds; to jump to another location, but save the location of the next instruction as a point to return to (e.g. a call). Other instructions include: saving many registers on the stack at once; moving large blocks of memory; complex and/or floating-point arithmetic (e.g., sine, cosine, square root); performing an atomic test-and-set instruction; instructions that combine ALU with an operand from memory rather than a register.

An additional embodiment of the present invention, for reducing power consumption, as provided by the core architecture, as disclosed herein, is the use of multiptexer-based registers with select/write logic for reducing gate count and energy consumption (FIG. 2).

The present invention may be easily implemented in a small hand-held device. For example, with greater than or equal to 10000 gates, with 32 bit on-chip microprogram control storage (basic 1k word RAM, extensible to 64K words and beyond), the device may be approximately 1.45 mm². Likewise, in a preferred embodiment, the present invention configured in a 90 nm CMOS ASIC process will utilize approximately 6 nW/gate/Mhz (typical process performance) with an approximate 500 to 1000 MHz maximum core clock speed (i.e., 10000 gates*6 nW/gate/Mhz*⅛ [statistical toggle/clock]=0.75 mW/MHz logic). Providing an improvement over the prior art with a presently calculated power consumption (operating at 1.0 GHz) of approximately 7.5 mW (with less than approximately 10 mW preferred). Computational performance is also enhanced whereby each line of microcode may perform on the order of 2× of a line of assembly code or greater efficiency.

As an example, current Industry State of the Art Computation Efficiency is illustrated in the following table:

| | | | | | pJ./Instr. |
|---|---|---|---|---|---|
| Processor | Performance | Power | | MIPS/Watt | (picoJ) |
| PowerPC 440GX | 1000 MIPS | 2.5 | W | 400 | 2500 |
| ARM10 | 400 MIPS | 90 | mW | 4400 | 228 |
| core | 1000 MIPS | 7.5 | mW | 133000 | 7.5 |

Additionally, the present invention has reduced core energy consumption since, as an aspect of the invention, a predetermined, fixed microarchitecture is used as the execution environment. This structure allows for hard ASIC implementation rather than the more flexible, but power hungry, FPGA implementations of the prior art. In the present invention, only a small logic footprint is required where data paths are sized to provide communication needs and power consumption reductions. Preferably, a 32 bit internal bus utilizing a 24 bit integer or the like may be utilized. Further, fine grained control may be utilized with fully decoded microcode tightly coupled to the data manipulation logic. In addition, the core is preferably designed with, for example, simple logic paths so as to enable register clock gating with most data manipulation logic comprised of data selectors or multiplexers that have low gate toggle statistics. Known prior art processor optimization techniques may also be employed where mesh size and bandwidth are necessary and power consumption is less critical, for example, pipeline processing, branch prediction and speculative execution. Presently, a single physical memory providing a minimal execution environment is preferred. On-chip execution memory as opposed to cache management hardware is preferred. Thus, contrary to the prior art, the present invention teaches a non-high-speed optimized architecture (NHSOA) having a core without pipeline processing, branch prediction, speculative execution, multiple memory space (whether physical or equivalent to a single memory) or an on-chip execution memory.

Likewise, the core of the present invention contains stacks but is not solely stack based. Rather, it differs from some prior art in that no instruction word is organized like an opcode, consequently no required instruction decoders are needed to interpret for the processor. Furthermore, the core uses a predetermined, fixed microarchitecture as the execution environment, which enables, in the preferred embodiment, the use of a hard ASIC implementation rather than an FPGA as in some prior art.

In FIG. 2, the core 200 is illustrated with hardware modules comprising the control unit directing a datapath unit. The control unit controls the steps taken by the datapath unit during the datapath's execution of an instruction (any or all of machine instructions, microinstructions or macroinstructions), including state management and control, and in a preferred embodiment the control unit (FIG. 2) is a microcoded control unit implemented as a microprogram in a control store, having a programmable microsequencer to execute the microprogram, with the microprogram comprising fully decoded microinstructions (e.g. with no need to decode these microinstructions in the control store). The datapath unit (or data manipulation subsystem) is controlled by the control unit and includes all circuits and functionality needed to execute the control unit instructions. The datapath unit includes such hardware as registers, function units such as ALUs (arithmetic logic units), shifters, interface units for main memory and I/O (data and address interface), RAM, including scratchpad RAM, internal busses, the instruction latch and parsing logic, the arithmetic-logic unit, the incrementer, the shift/rotate logic unit, and multi-port register file. Hence, the data-path section provides the data manipulation and processing functions required to execute the instruction set. Scratchpad RAM 210 is a memory cache reserved for direct and private usage by the CPU.

The register file 220 may have a multiport design to achieve the parallelism needed for high execution speed and compact microcode. During every microcycle, file locations are output, and, at the end of the microcycle, file locations are written back. The register file may have inputs for a plurality of stack registers, one or more counters, shift registers, general purpose registers, and architectural pointers. Architectural pointers may include pointers for the code-environment pointer, program counter, the data environment, local environment, top of the stack, all for dynamically allocating and identifying variables and parameters on the stack. Addressing the data and instructions may reside conceptually on different memories (Harvard Architecture) though in fact the memories can be combined (unified cache).

A Frame Checking Sequence (FCS) Generator block 230 may be utilized to calculate CRC (cyclical redundancy checking) across any transmitted data. A special purpose logic unit 240 may be employed to enhance network security or the like. A CAM 250 (Content Addressable Memory) allows for very fast table lookup, useful for network routing, and a preferred environment for the core. Internal and external memory buses exist, as labeled in FIG. 2, for connection of the microprocessor control and datapath units to internal and external memory.

A 16-bit ALU block 255 provides addition, logical operations, and indications of sign, all-zero, carry, and over-flow status. The R and S inputs to the ALU are fed from multiplexing logic in order to provide several source alternatives. Several formats are preferably included to support efficient multiplication and division algorithms.

An instruction latch receives microinstruction words from program memory for each fetch initiated. The incoming words are fully decoded microcode; the words are passed to the microcontroller to initiate instruction execution. Immediate data is fed to the ALU as S source operands.

The 16-bit instruction latch provides partial took-ahead. When the microcontroller is ready to start executing another instruction, the fully decoded microinstruction is either in memory or already fetched and resident in the latch.

Microinstruction words are fetched from the code environment and stored in an instruction latch. Execution begins with the translation of the fully decoded microinstruction word into a starting microprogram location. The microcontroller then steps through control store locations to cause proper execution of the instruction. If an interrupt condition is pending, the microcontroller automatically enters an appropriate service micro routine before executing the next instruction.

In an exemplary embodiment, the control store 260 is implemented with a 1K×48 ROM. It contains microsequences or fully decoded microcode for each of the machine language instructions and for initialization, interrupt servicing, and exception handling. The output of the ROM is loaded into a microinstruction register 262 (labeled μINSTRUCTION REGISTER in FIG. 2) at the end of each microcycle. The register outputs determine which operations are to occur during the current microcycle. Microinstruction fetch and execution are overlapped.

The function of the microsequencer 264, which can be controlled by the microsequencer controller 266 (FIG. 2) is to generate the IO-bit microaddress fed to the control-store ROM. At each microprogram step, the next microaddress is selected from one of the following sources:
1. the microprogram counter 268 (the register labeled “pPC REG” in FIG. 2) containing the address of the current microinstruction incremented by one;
2. 10-bit jump address 270 emanating from the field of the current microinstruction and allowing nonsequential access to the control store 268 (the line 274 labeled “JUMP ADDRESS” in FIG. 2);
3. a save register 272 previously loaded from the microprogram counter to establish the return linkage from a called microsubroutine;
4. the current fully decoded microinstruction word from line labeled “CMD” in FIG. 2, which is operatively connected to the microinstruction register 262 (labeled μINSTRUCTION REGISTER in FIG. 2) and/or receives microinstructions from a stored microprogram that is loaded from external memory to the core chip (a command line may be provided and may be either external to the device or attached to the microinstruction register 262; or
5. jam logic 276 (from line labeled “JAM” in FIG. 2) for generating the starting microaddress for initialization and interrupt servicing.

The selection of the next microinstruction to be executed is in some cases, conditional on the state of a particular status line. To determine this state, preferably eight status lines are fed to the test multiplexer, shown in FIG. 2 as triangular shaped test mux 280. Conditional and unconditional jump, map, call, and return operations can then be selected by the microprogrammer.

Clock logic includes oscillator circuitry and divide-by four logic to produce the necessary internal timing signals. The clock logic allows pauses to be inserted as required during memory accesses. Intertwined with the clock logic is bus-acquisition and read/write control logic.

The microcode-control-store ROM 260 is configured as 1024 words, each 48 bits in length, conceptually shown in FIG. 2 by dividing the microinstruction register 262 into blocks 282. The 48-bit microinstruction word may then be divided into subfields as shown in FIG. 2. In a preferred embodiment the format is “horizontal,” having minimum overlap in field definitions to allow maximum parallel operation in the data paths. A two pass microassembler may be used to translate symbolic microprogram source into object code. The ROM control store 260 may be replaced by an EPROM, EEPROM or flash memory.

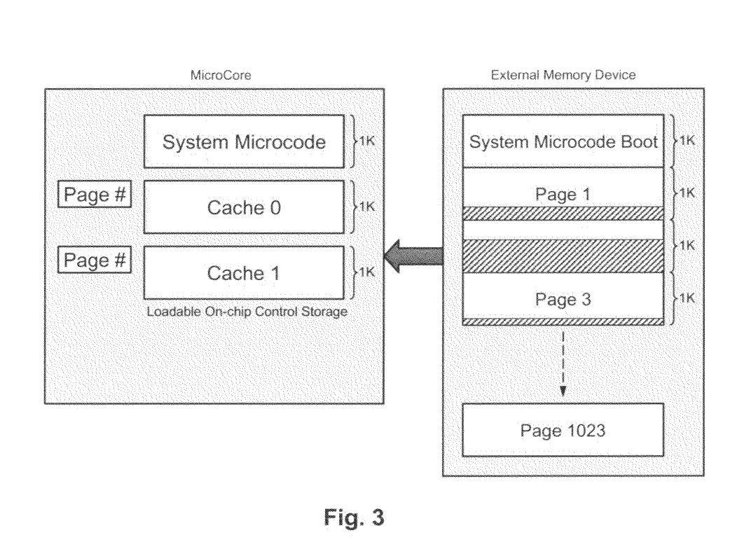

Turning attention to FIG. 3, there is shown block diagram of the core cache architecture for the network processor of the present invention. Cores have been identified as an approach for the implementation of very small, low power embedded computing systems, as disclosed in commonly assigned and co-pending U.S. patent application Ser. No. ______, docket no. 06-CR-508, incorporated by reference herein. The described Network Processor core is designed with further simplification to reduce the size and power footprint to less than 10 mw. The object of the present invention is to provide a means for the microcode program size to be much larger—for example 1 Mwords or more, by means of a kind of virtual memory system. A microprogram of this size could implement system designs of substantial complexity, while still utilizing a small, low power microarchitecture core.

Large microprograms may be utilized while keeping the execution core small through a cache to load and execute small portions of the large microprogram. The microprogram storage organization may include three blocks: (1) a system microprogram block for initialization, control and system management functions, shown in FIG. 3 as the block labeled “System Microcode”; (2) a first microprogram execution cache that is loaded with microcode from external memory, shown in FIG. 3 as the block labeled “Cache 0”, and (3) a second microprogram execution cache that is also loaded with microcode from external memory, shown in FIG. 3 as the block labeled “Cache 1”. The external memory is shown in FIG. 3 as the block labeled “External Memory Device”. Each of these blocks has words of about 1 k in size. The external memory may be RAM (SRAM or SDRAM) or Flash.

The microprogram caches operate in “ping-pong” manner, in that while a microprogram is executing from one cache, the other may be loaded with a next cache page from external memory. Determination of which cache page to load, and when to load it is under control of the system microcode, and possibly with the assistance of directives in the microcode that is currently executing from cache.

The operation of this “cached” microcoded architecture is as follows:
1. The System microcode is always resident. It provides interfaces to IRQ and Test Inputs (discrete signal events), controls program execution page loads into cache, performs error recovery, and other system functions.
2. The System microcode boots from external memory on initialization and loads the first executable page of microcode (Page 1) into Cache 0.
3. Execution begins at address 0 of Cache 0. Addresses on each microcode page are indexed to 0 and identified by page # for simple, efficient microcode execution.
4. During execution of the microprogram in Page 1, the next page to run is identified.
5. The System microcode initiates loading that page into Cache 1.
6. At the time determined by a Page Branch directive in the execution of the microcode in Page 1, control and execution are passed to the page in Cache 1.
7. The process continues indefinitely. Each page of microcode is a major microcode block. Each page can be any size but in the example shown in FIG. 3 preferably 1 k bytes. These contents of these page microcode blocks may be created by manual microcode development, or they may be generated by a host based development tool. Each page of microcode need not be full, but the closer the pages are to being full, the more efficient the use of external memory.
8. The size of the caches and the microcode blocks may be selected based on the statistics and profiles of the cache loads, microcode blocks and load times.
9. Local branches can be done in-page. Long branches require a page load. An immediate long branch would cause a core stall while cache lines (or whole pages) are filled from external memory.

The external memory for the present invention may be RAM (SRAM or SDRAM) or Flash. Use of external Flash memory would allow a generally smaller and possibly lower power system, but its execution speed might be slower depending on how long each page of microcode in the cache stays resident before a new page is needed. This will generally be a factor of looping through code in page rather than simple sequential execution through the page. In FIG. 3 up to 1024 pages (1 byte each) or 1024 bytes (2̂10) are shown, but in general any number of pages may be stored in external memory.

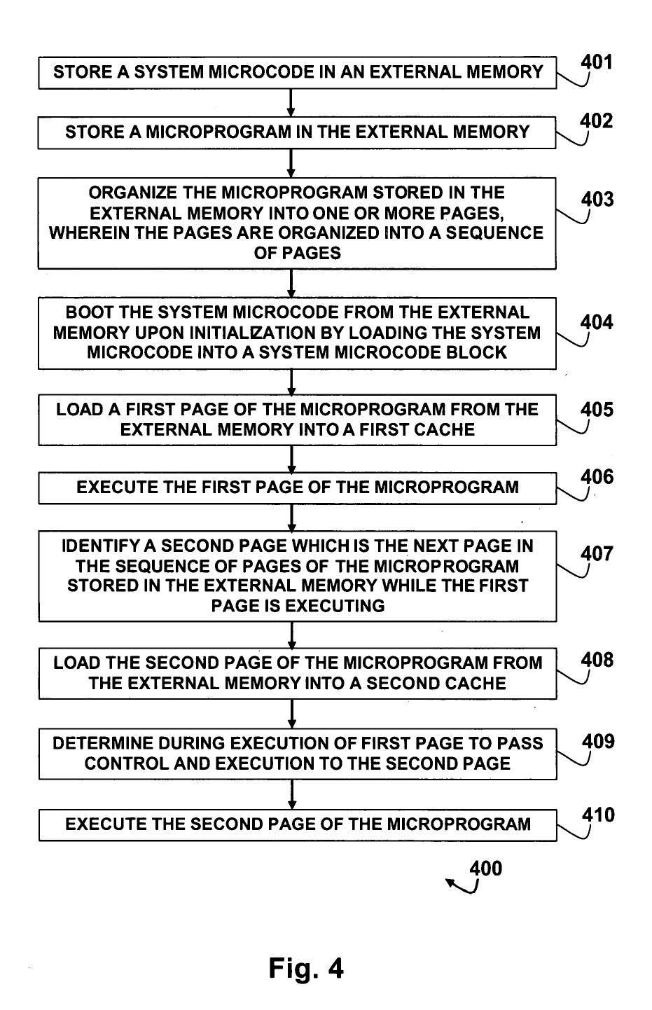

Referring now to FIG. 4; a method 400 of method of running a microprogram on a core of a microprocessor, in accordance with an exemplary embodiment of the present invention, is shown. In step 401, a system microcode is stored in an external memory. In step 402, a microprogram is stored in the external memory. In step 403, the microprogram stored in the external memory is organized into one or more pages, the pages being organized into a sequence of pages. In step 404, the system microcode is booted from the external memory upon initialization by loading the system microcode into a system microcode block. In step 405, a first page of the microprogram is loaded from the external memory into a first cache. In step 406, the first page of the microprogram is executed. In step 407, a second page, which is the next page in the sequence of pages of the microprogram stored in the external memory, is identified while the first page is executing. In step 408, the second page of the microprogram is loaded from the external memory into a second cache. In step 409, control and execution is determined to be passed to the second page during execution of the first page. In step 410, the second page of the microprogram is executed.

It is intended that the scope of the present invention extends to all such modifications and/or additions and that the scope of the present invention is limited solely by the claims set forth below.

What is claimed is:

1. A method of running a microprogram on a core of a microprocessor comprising the steps of:
storing a System microcode in an external memory;
storing a microprogram in the external memory;
organizing the microprogram stored in the external memory into one or more pages, wherein the pages are organized into a sequence of pages;
booting the System microcode from the external memory upon initialization by loading the System microcode into a System microcode block;
loading a first page of the microprogram from the external memory into a first cache;
executing the first page of the microprogram;
identifying a second page which is the next page in the sequence of pages of the microprogram stored in the external memory while the first page is executing;
loading the second page of the microprogram from the external memory into a second cache;
determining during execution of the first page of the microprogram in the first cache to pass control and execution to the second page of the microprogram;
executing the second page of the microprogram.

2. The method of claim 1, wherein the external memory is selected from static random access memory, synchronous dynamic random access memory, and flash memory.

3. The method of claim 1, wherein the steps of loading a first page and loading a second page are performed by the System microcode.

4. The method of claim 1, wherein the steps of executing a first page and a executing a second page are performed by the System microcode.

5. The method of claim 1, wherein the microprogram is at least 64k words in size.

6. The method of claim 1, wherein the first cache includes an execution start address wherein execution of the first page begins at the execution start address and wherein the second cache includes an execution start address wherein execution of the second page begins at the execution start address.

7. The method of claim 1, wherein the core is a Network Processor core.

8. A system for running a microprogram on a core of a microprocessor, comprising:
a microprocessor including an execution core;
a first cache;
a second cache;
an external memory, which includes a microprogram and a System microcode;
a System microcode block;
wherein the microprogram stored in the external memory is organized into a sequence of one or more pages, the system boots the System microcode from the external memory by loading the System microcode into the System microcode block, the system loads a first page of the microprogram into the first cache, the system executes the first page of the while identifying a second page of the microprogram which is the next page in the sequence of pages of the microprogram and loading the second page into the second cache, the system determines to pass control and execution to the second page, and the system executes the second page.

9. The system of claim 8, wherein the external memory is selected from static random access memory, synchronous dynamic random access memory, and flash memory.

10. The system of claim 8, wherein the loading of a first page and loading of a second page is performed by the System microcode.

11. The system of claim 8, wherein the execution of a first page and execution of a second page is performed by the System microcode.

12. The system of claim 8, wherein the microprogram is at least 64k words in size.

13. The system of claim 8, wherein the first cache includes an execution start address wherein execution of the first page begins at the execution start address and wherein the second cache includes an execution start address wherein execution of the second page begins at the execution start address.

14. The system of claim 8, wherein the core is a Network Processor core.

15. A system for running a microprogram on a core of a microprocessor, comprising:
means for storing a System microcode and a microprogram in an external memory;
means for booting the System microcode upon initialization by loading the System microcode into a System microcode block;
means for organizing the microprogram sequentially in one or more pages;
means for loading a first page into a first cache;
means for executing the first page while identifying a second page which is the next page in the sequence of pages of the microprogram and loading the second page into a second cache;
means for determining to pass control and execution to the second page of the microprogram; and
means for executing the second page.

16. The system of claim 15, wherein the external memory is selected from static random access memory, synchronous dynamic random access memory, and flash memory.

17. The system of claim 15, wherein the loading means for loading a first page and for loading a second page is controlled by the System microcode and wherein the execution means for executing the first page and executing the second page is controlled by the System microcode.

18. The system of claim 15, wherein the microprogram is at least 64k words in size.

19. The system of claim 15, wherein the first cache and the second cache include an execution start address wherein the execution means begins executing a page loaded into the cache at the execution start address.

20. The system of claim 15, wherein the core is a Network Processor core.
